(19) United States
(12) Patent Application Publication
(10) Pub. No.: US 2001/0054114 A1
(43) Pub. Date: Dec. 20, 2001

(54) Wireless data transport of internet content to display device

(76) Inventors: Mary DuVal, Farmers Branch, TX (US); Thomas M. Siep, Garland, TX (US); Frank J. Moizio, Dallas, TX (US); Lars Yoder, Plano, TX (US)

Correspondence Address: TEXAS INSTRUMENTS INCORPORATED, P O BOX 655474, M/S 3999, DALLAS, TX, 75265

(21) Appl. No.: 09/802,353

(22) Filed: Mar. 9, 2001

Related U.S. Application Data
(60) Provisional application No. 60/191,287, filed on Mar. 21, 2000.

(51) Int. Cl. G06F 15/16

(52) U.S. Cl. 709/247; 345/503

(57) ABSTRACT

A display device (10) for wirelessly receiving internet content, in the form of HTML commands (12), as well as commands for controlling operation of the display device (10). The display device (10) has an embedded processor (22), programmed with a browser to interpret the HTML commands, and additional programming for generating pixel data based on the HTML commands and associated data files. A display engine (26) receives the pixel data and generates displays.

### BACKGROUND OF THE INVENTION

In the past few years, various computing products have become available that permit users to create, use, and gain wireless access to internet content. Examples of such products are cell phones, laptop computers, personal digital assistants (PDAs).

Many of these computing products come equipped with a built in display. However, these displays tend to be limited in screen size and resolution and in the overall quality of the display. Attempts have been made to display high resolution images using larger display devices, such as projectors. When wireless connectivity between a computing device and the larger display device has been attempted, the results are crude bit map or rendered pixel data displays.

### SUMMARY OF THE INVENTION

Many portable electronic devices such as PDAs are incorporating internet browsers with wireless access capabilities. This allows the remote users wireless access to HTML information when they access the internet. The user, for example, could create a presentation (or any other form of information) in HTML format and store the presentation on a server with a specific URL address. From a remote location, the user can gain wireless access to this HTML presentation from the internet using a portable electronic device such as a PDA. The remote user can then use the portable electronic device to transmit this HTML presentation to a HTML/XML-enabled display device using Bluetooth technology or some other wireless technology. The presentation would be transmitted like other HTML information, as HTML commands and associated file transfers, to reduce the necessary wireless bandwidth. Control commands and responses from the projector will be formatted as XML commands. The presentation could be retrieved by a PDA that connects with a wireless internet service provider or could have been downloaded before the remote user leaves their desk or fixed location. The HTML presentation information would then be transmitted to the HTML/XML-enabled display device.

The HTML-enabled display device would contain an RF receiver, a microprocessor, a DSP, a memory module, as well as components typically found in a display device. This device would be the primary receiver of information, but may be called upon to transmit responses occasionally. The memory module would be used to store files transferred in association with the chosen HTML page. A plug-in module will allow scalability for the user. The microprocessor would contain a micro web browser, plug-in modules needed to support desired web functionality, appropriate media players, a Java Virtual Machine to interpret Java Applets, a real-time operating system that includes a 2D graphics rendering engine and the appropriate hardware drivers. The DSP would be used to decompress image, video and audio files.

The primary transmitter of information will be the portable electronic devices. The user would download a display device driver to a portable electronic device such as PDA. This would allow the PDA or other portable electronic device control menu capability for the specific display device in use by transmitting XML commands to the projector.

### BRIEF DESCRIPTION OF THE DRAWINGS

FIG. 1 illustrates a display device having a wireless connection to an internet access device in accordance with the invention.

FIG. 2 is a block diagram of the internal components of the display device, configured to receive and display internet content in accordance with the invention.

### DETAILED DESCRIPTION OF THE INVENTION

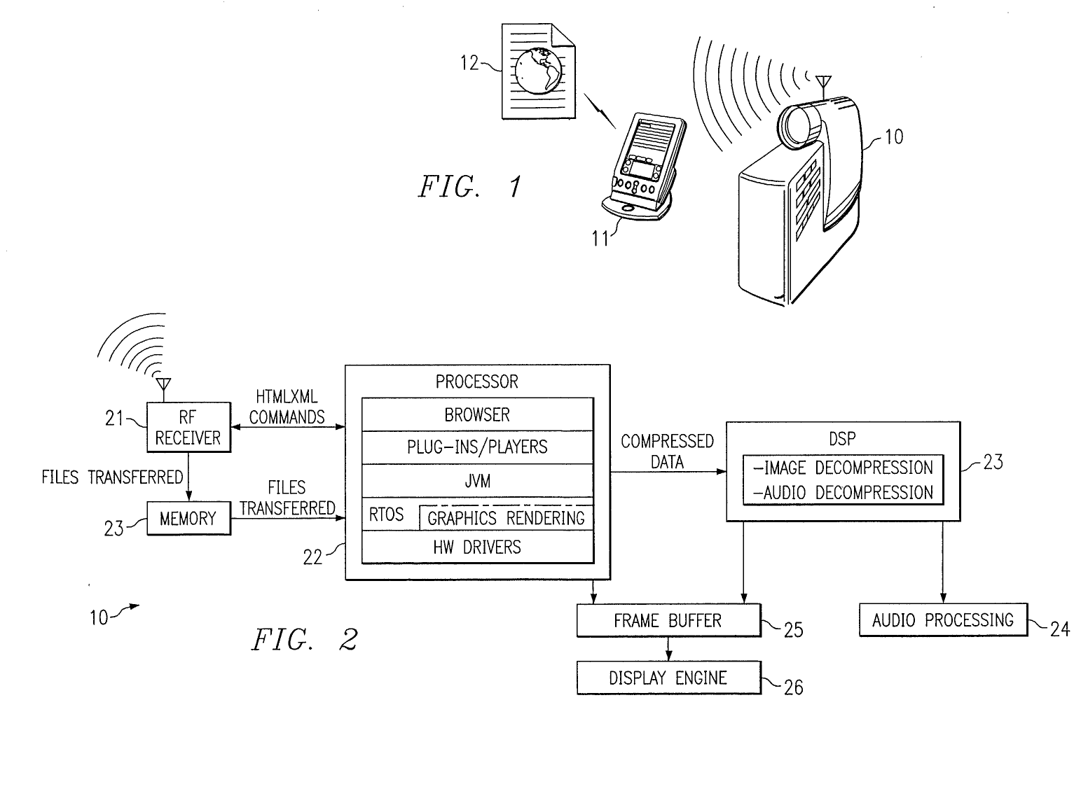

FIG. 1 illustrates a display device 10 having a wireless connection to an internet access device 11 in accordance with the invention. The display device 10 receives internet content, in the form of HTML data 12 and associated images, from the internet access device 11. The display device 10 may also be remotely controlled from the internet access device 11. The HTML data 12 represents a referenced web page to be displayed on the display device. For example, HTML data 12 might represent slides for a presentation to be projected on a display screen.

In the example of FIG. 1, display device 10 is a projection display having SLM (spatial light modulator) type display electronics. For example, display device 11 might be a device whose images are generated by a spatial light modulator, such as an LCD array or a DMD (digital micromirror device) array. However, the same concepts could be applied to a CRT display having appropriate digital to RBG conversion capability.

In any event, it is assumed that display device 11 is capable of receiving digital display data and of converting the data to a format suitable for its particular display electronics. As explained below, for purposes of displaying internet content in accordance with the invention, display device is “browser-enabled”.

For purposes of example, internet access device 11 is a mobile computing device, such as personal digital assistant (PDA). Examples of other types of mobile computing devices suitable for transferring internet content to display device 10 are cell phones and notebook computers. Alternately, the internet access device 11 could be some other computer equipment, such as a desktop computer. It is further possible that a computer could be used to create original internet content, in the form of HTML data 12, which could then be transferred to display device 10. Regardless of the origin of the HTML data 12, it is assumed that access device 11 has transmitting circuitry for wirelessly transmitting the HTML data to display device 10.

In operation, internet access device 11 is used to receive content, such as HTML data 12, from the internet. Thus, it is assumed that internet access device 11 has internet browser application programming. This capability permits users to view web pages when the HTML data is accessed.

For purposes of this description, the internet content is assumed to be HTML data 12, wherein “HTML data” is meant to include both HTML commands and associated data files. “HTML” is short for HyperText Markup Language, the authoring language used to create documents on the world wide web. HTML defines the structure and layout of a Web document by using a variety of tags and attributes. The correct structure for an HTML document starts with <HTML><HEAD>(enter here what document is about)</HEAD><BODY> and ends with </BODY></HTML>. All the information to be included in a Web page fits in between the <BODY> and </BODY> tags. There are hundreds of other tags used to format and layout the information in a Web page. For instance, <P>is used to make paragraphs and <I>. . . </I>is used to italicize fonts. Tags are also used to specify hypertext links. These allow Web developers to direct users to other Web pages with only a click of a mouse on an image or word(s). HTML is one way of defining and interpreting tags in accordance with the rules of SGML (standard generalized markup language).

Using the HTML format, a user can create display data representing one or more frames to be displayed on display device 10. The user then stores the display data on a server with a specific URL address. This data is indicated on FIG. 1 as HTML data 12. In other embodiments, the HTML data could be stored locally on the computing device.

Once the display data is stored and accessible, the user may gain wireless access to the HTML data 12 using internet access device 11. The user then downloads the HTML data 12 to the internet access device 11.

Next, the user transmits the HTML data 11 from memory of internet access device 11 to display device 10. As explained below, this transmission is accomplished by transmitting commands and compressed files rather than pixel data. The HTML data, now stored in internet access device 11, is transmitted as HTML commands and file transfers. Internet access device 11 may also be used to generate control commands and responses associated with display device 10, using XML commands. XML (extensible markup language) is a modified version of SGML, designed especially for web documents and permits web designers to create customized tags. Using XML commands, internet access device 11 can be used to interrogate display device 11 to determine its control commands, and to generate an appropriate user interface. In this manner, internet access device 11, in addition to controls integrated into the display device 10, can be used for user control.

FIG. 2 is a block diagram of the internal components of display device 10, configured to receive and display internet content from an internet access device in accordance with the invention. Only those components that play a role in the HTML data path are shown; the display device might also have data paths for other types of graphics data received in digital or analog form. Display device 10 might also have various user interface features, although a feature of the invention is that internet access device 11 can be used to generate commands that control the operations of the display device 10.

An RF receiver 21 receives HTML and XML data from internet access device 11. Receiver 21 may be implemented in accordance with the “Bluetooth” (TM) standard, which refers to a set of open specifications for wireless communications of data and voice. The Bluetooth technology is aimed at achieving cable replacement through a wireless point to point link with one or several devices. It also aims to simplify data synchronization between internet devices and other computers. The receiver 21 operates on a globally available 2.45 Ghz radio band and supports data speeds of up to 721 Kbps as well as three voice channels. Alternatively, receiver 21 may be implemented with some other wireless standard, such as the IEEE 802.11A, 802.11B, or IrDA (Infrared Data Association) standards.

In other embodiments, receiver 21 may be a two-way transceiver. This would permit display device 10 to transmit as well as receive commands. There may be applications in which it would be useful for display device 10 to transmit responses. For example, display device 10 might respond to an inquiry about the display device's user interface.

As indicated in FIG. 1, receiver 21 delivers HTML and XML commands to microprocessor 21. It also transmits any files associated with the HTML content to memory 23. Memory 23 may be any type of memory, but is typically a plug-in type memory such as flash or smart memory.

Microprocessor 22 receives HTML and XML commands from receiver 21. The HTML content is received by browser application programming, which may be implemented with conventional programming used for displaying web pages or may be a “micro-browser” of the type associated with computing devices specialized for internet access. More sophisticated browsers can present multimedia, which includes sound and video, as well as graphics. Essentially, the browser interprets the HTML data as well as any special files, such as JPEG or animation files. It interprets the XML commands, which then control its operation.

Microprocessor 22 may be further programmed with various browser add-ons, also known as plug-ins and players, which assist in presentation of different types of audio, graphic, and video data. A Java virtual machine (JVM) acts as an interpreter of Java commands for the operating system of microprocessor 22. Its primary task is the interpretation of Java applets.

In the example of FIG. 2, microprocessor 22 is “embedded” in display device 10. As such, its operating system is of a type known as a real time operating system (RTOS). The primary task of the RTOS is to automatically execute software routines in response to external events. The operating system kernel performs tasks such as interrupt handling, task scheduling, resource-sharing, and memory management. Calls to the kernel's application interface request the kernel's services. For purposes of the present invention, a key task requested of the RTOS is to respond in real time to communications from internet access device 11.

A graphics rendering unit translates commands generated by the browser application into pixel data. It may be implemented in the manner most appropriate for the display engine 26. For example, for a DMD type display engine, graphics rendering may be performed with specialized hardware logic. In this case, microprocessor 22 might be implemented as a larger chip set or ASIC that also includes the graphics rendering engine.

Microprocessor 22 is further programmed with drivers that translate operating system commands into hardware specific commands. The data passed from microprocessor 22 to frame buffer 24 is in the form of pixel data suitable for display rendering. Any specialized formatting, such as the “bit plane” formatting used by DMD-type display engines may be performed by processor 22, by the manner of reading into or writing from frame buffer 24, or by additional software or hardware.

If the HTML data is accompanied by compressed data files, such as JPEG files, a special digital signal processing (DSP) unit 23 may be used to perform decompression tasks. DSP unit 23 may be programmed to operate on both image data and audio data. Audio processing unit 24 handles presentation of audio data. The use of a separate DSP unit 23 to offload compression tasks from microprocessor 22 reduces graphics rendering time.

The image data from microprocessor 22 or DSP unit 23 is stored in a frame buffer 25 prior to display. Frame buffer 25 may be any type of memory, with data stored and accessed in a manner appropriate for display engine 26.

Display engine 26 contains some sort of image generation device. Examples of suitable image generation devices are spatial light modulators, such as liquid crystal arrays or digital micromirror device (DMD) arrays. The latter is commercially available from Texas Instruments, Incorporated. Display engine 26 has whatever optics and electronics associated with the particular image generation device.

Referring again to FIG. 1, the internet access device 11 is the transmitter of data to the display device 10. The user may download a display device driver to the internet access device, which permits the internet access device 10 to control menus and other user interface features associated with display device 10. In response to user input, XML commands are transmitted from the internet access device 11 to the display device 10. In other words, the internet access device 11 may be used a remote control.

Other Embodiments

Although the present invention has been described in detail, it should be understood that various changes, substitutions and alterations can be made hereto without departing from the spirit and scope of the invention as defined by the appended claims.

What is claimed is:

1. A display device for receiving and displaying internet content, comprising:
a short range radio frequency receiver operable to receive HTML commands representing internet content;
a processor programmed to interpret the HTML commands and to generate pixel data, based on the HTML commands, suitable for a rendered display;
a frame buffer operable to store the pixel data; and
a display engine operable to receive the pixel data from the processor and to render the display on the basis of the pixel data.

2. The display device of claim 1, wherein the receiver is further operable to receive data files associated with the HTML commands.

3. The display device of claim 2, wherein data files are compressed data files, and further comprising a digital signal processor for receiving the compressed data files from the processor, decompressing the data files, and passing the decompressed data to the frame buffer.

4. The display device of claim 1, wherein the receiver is further operable to receive XML data representing commands for operation of the display device, and wherein the processor is further programmed to interpret the XML data.

5. The display device of claim 1, wherein the receiver operates in accordance with bluetooth specifications.

6. The display device of claim 1, wherein the receiver operates in accordance with IEEE specifications.

7. The display device of claim 1, wherein the display engine has a spatial light modulator for rendering displays.

8. The display device of claim 7, wherein the spatial light modulator is a digital micromirror device.

9. The display device of claim 7, wherein the receiver is part of a two way RF transceiver.

10. The display device of claim 1, wherein the processor is an embedded processor.

11. The display device for claim 1, wherein the receiver operates in accordance with IrDA specifications.

12. A method of using a display device to wirelessly receive and display internet content, comprising the steps of:
receiving internet content, in the form of HTML commands, by means of a short range wireless receiver;
interpreting the HTML commands
generating pixel data based on the HTML commands, using a processor embedded in the display device;
delivering the pixel data from the microprocessor to a display engine; and
generating displays based on the pixel data.

13. The method of claim 12, further comprising the step of receiving data files associated with the HTML commands, by means of the wireless receiver.

14. The method of claim 13, wherein the data files are compressed data files, and further comprising the step of decompressing the data files, using a processor embedded in the display device.

15. The method of claim 14, wherein the decompressing step is performed using an embedded digital signal processor in communication with the microprocessor.

16. The method of claim 12, further comprising the step of receiving display operation data, by means of the wireless receiver, and of interpreting the display operation data.

17. The method of claim 16, wherein the display operation data is in the form of XML data.

18. The method of claim 12, wherein the step of receiving internet content is performed in accordance with bluetooth specifications.

19. The method of claim 12, wherein the step of receiving internet content is performed in accordance with IEEE specifications.

20. The method of claim 12, wherein the step of generating displays is performed with a spatial light modulator.

21. The method of claim 20, wherein the spatial light modulator is a digital micromirror device.

22. The method of claim 12, wherein the receiving steps are performed by receiving the HTML commands and display operation data from a mobile internet access device.

23. The method of claim 12, wherein the step of receiving Internet content is performed in accordance with IrDA specifications.

24. The method of claim 12, wherein the generating step is performed using a graphics rendering process.
